(19) United States
(12) Patent Application Publication
(10) Pub. No.: US 2007/0191256 A1
(43) Pub. Date: Aug. 16, 2007

(54) Fabric care compositions comprising formaldehyde scavengers

(76) Inventors: Renae Dianna Fossum, Middletown, OH (US); Jean-Francois Bodet, Waterloo (BE); Jiten Odhavji Dihora, Hamilton, OH (US); Glenn Thomas Jordan IV, Indian Springs, OH (US); Sanford Theodore Kirksey JR., Cincinnati, OH (US); Leslie Dawn Waits, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/351,718

(22) Filed: Feb. 10, 2006

(51) Int. Cl. C11D 3/00

(52) U.S. Cl. 510/515

(57) ABSTRACT

Fabric care compositions comprising formaldehyde scavengers exhibit low levels of free formaldehyde.

### FIELD OF INVENTION

The present invention relates to compositions comprising formaldehyde scavengers.

### BACKGROUND OF THE INVENTION

Perfume microcapsules and the use of perfume microcapsules in fabric care compositions is known. See e.g., US 2003/0125222 A1. However, some microcapsules contain formaldehyde or generate formaldehyde over time. It is thought that the shell material used to manufacture the shell of the microcapsule may be responsible for the formation of free formaldehyde. For example, these shell materials include melamine-formaldehyde, urea-formaldehyde, phenol-formaldehyde, or other condensation polymers with formaldehyde. Nevertheless formaldehyde based resins such as melamine-formaldehyde or urea-formaldehyde resins are especially attractive for perfume encapsulation due to their wide availability and reasonable cost. However, these microcapsules may emit formaldehyde. There are several sources of this released formaldehyde, e.g., unreacted excess formaldehyde, hydrolysis and products formed from the reaction of formaldehyde and urea or formaldehyde and melamine, as well as decomposition of the resin from age, humidity, temperature, pH, etc. Formaldehyde is very volatile, has a very unpleasant odor which irritates the eyes and nasal passages and may give rise to other health problems. Formaldehyde has been classified as a human carcinogen by the International Agency for Research on Cancer and as a probable human carcinogen by the U.S. Environmental Protection Agency. It is important for both health and aesthetic reasons not only to limit the concentration of formaldehyde in the environment during the production of the products utilizing formaldehyde based resins but also to minimize the amounts of formaldehyde released from these products over the useful life of these products. Therefore, there is a need to decrease formaldehyde exposure in products prepared from formaldehyde or that can generate formaldehyde during use.

### SUMMARY OF THE INVENTION

The present invention attempts to address this and other needs by the surprising discovery that the use of certain formaldehyde scavengers in fabric care compositions, particularly those fabric care compositions that comprise perfume microcapsules, may reduce the level of free formaldehyde in the composition. Therefore one aspect of the invention provides a fabric care composition comprising a fabric softening active, a perfume microcapsule, and a formaldehyde scavenger. Methods of using the fabric care compositions of the present invention to treat fabric are provided. Kits comprising the fabric care compositions are also provided.

### DETAILED DESCRIPTION OF THE INVENTION

Formaldehyde Scavenger

One aspect of the invention provides for a composition comprising a formaldehyde scavenger. The term “formaldehyde scavenger” is used herein the broadest sense to include any compound that reduces the level of formaldehyde in a composition of the present invention, provided the formaldehyde scavenger is safe for humans and does not include ammonia, ethylene urea, tryptophan, 5-hydroxytryptophan, hydroxyl amine, hydroxylamine sulfate, barbituric acid.

Ammonia is observed as an undesirable formaldehyde scavenger, particularly under acidic conditions, because ammonia reacts with formaldehyde to form hexamethylene tetramine, which is unstable under acidic conditions. Many fabric care compositions are acidic.

Ethylene urea, although an effective formaldehyde scavenger, is undesirable because it is listed as a carcinogen on the European Registration R40.

Tryptophan or 5-hydroxytryptophan is not desirable because of potential health risks that have been associated with tryptophan since the FDA and the Center for Disease Control has established a link between a sometimes fatal blood disorder called eosinophilia-myalgia syndrome and tryptophan. Although, tryptophan occurs in many foods and investigation has not established whether it or an impurity introduced during manufacture or distribution is the cause, an import alert remains in force which limits the importation of L-tryptophan into the United States, except if it is intended for an exempted use such as pharmaceuticals.

Hydroxylamine is not desirable since chronic exposure in laboratory experiments has shown mutagenic effects. Hydroxylamine sulfate is not desirable since it is considered a potential teratogen.

Barbituric acid is an effective formaldehyde scavenger, however it is not desirable since its use is regulated as a drug in, for example, Canada.

In one embodiment of the invention, the formaldehyde scavenger is one that is effective at scavenging formaldehyde in low pH, e.g., about pH 2 to about pH 6, alternatively about pH 3 to about pH 4.

In another embodiment of the invention, the formaldehyde scavenger itself is not toxic (e.g., a carcinogen) to humans.

In another embodiment, the formaldehyde scavenger is chosen from: sodium bisulfite, urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), poly(vinyl amine), hexane diol, ethylenediamine-N,N′-bisacetoacetamide, N-(2-ethylhexyl)acetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, benzylamine, hydroxycitronellol, cyclohexanone, 2-butanone, pentane dione, dehydroacetic acid, chitosan, or a mixture thereof.

In another embodiment, the formaldehyde scavenger is chosen from: sodium bisulfite, urea, cysteine, lysine, glycine, serine, 3,4-diaminobenzoic acid, allantoin, glycouril, ethyl acetoacetate, acetoacetamide, malonamide, ascorbic acid, 1,3-dihydroxyacetone dimer, biuret, oxamide, benzoguanamine, pyroglutamic acid, succinamide, triazole, sulfanilic acid, oxamide, glucose, cellulose, poly(vinyl alcohol), poly(vinyl amine), hexane diol, ethylenediamine-N,N′-bisacetoacetamide, N-(2-ethylhexyl)acetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, dibutyl amine, hydroxycitronellol, dehydroacetic acid, chitosan, or a mixture thereof.

In another embodiment, the formaldehyde scavenger is chosen from sodium bisulfite, ethyl acetoacetate, acetoacetamide, ethylenediamine-N,N′-bisacetoacetamide, ascorbic acid, 2,2-dimethyl-1,3-dioxan-4,6-dione, helional, triplal, lilial or a mixture thereof. These formaldehyde scavengers may be obtained from Sigma/Aldrich/Fluka.

In another embodiment, sodium bisulfite is an effective formaldehyde scavenger and can reduce residual formaldehyde in the fabric care composition when the sodium bisulfite is used at excess molar concentrations of from about 1:1 to about 5:1, alternatively from about 2:1 to about 4:1, alternatively about 2:1 to about 5:2, alternatively about 5:2 to about 5:1, relative to the amount of free formaldehyde in the perfume microcapsule composition. The phrase “perfume microcapsule composition” means a composition comprising a perfume microcapsule. In turn, the perfume microcapsule comprises a perfume core, which in turn comprises a perfume and optionally a diluent. The shell of a perfume microcapsule encapsulates the perfume core. The weight percentage of the perfume in the perfume core of a perfume microcapsule (“encapsulated perfume”) can be calculated as a weight percentage (wt %) of a fabric care composition of the present invention by the following equation (1): wt % of encapsulated perfume of a fabric care composition={[Overall mass (g) of a perfume microcapsule composition)]×[wt % of solid components of the perfume microcapsule composition (i.e., the perfume core and shell components of the microcapsule), with respect to overall weight of the perfume microcapsule composition]×[wt % of the perfume in the perfume core, with respect to overall weight perfume microcapsule]×[wt % of the diluent in the perfume core, with respect to the weight of the perfume core (i.e., perfume and diluent of the perfume core) %)]}/[mass (g) of the fabric care composition)] (eq. 1). In one embodiment, the perfume core does not comprise a diluent or is substantially free of a dilutent.

In one embodiment, the amount of encapsulated perfume in the fabric care composition is from about 0.1% to about 2%, more preferably from about 0.15% to about 0.75% by weight of the fabric care composition.

The term “free formaldehyde” means those molecular forms in aqueous solution capable of rapid equilibration with the native molecule, i.e., H₂CO, in the headspace over the solution. This includes the aqueous native molecule; its hydrated form (methylene glycol; (HOCH₂OH)); and its polymerized hydrated form (HO(CH₂O)ₙH). These are described in detail in a monograph by J. F. Walker (Formaldehyde ACS Monograph Series No. 159 3rd Edition 1964 Reinhold Publishing Corp.).

The moles of free formaldehyde in the perfume microcapsule composition are determined in the absence of the formaldehyde scavenger, and then the molar excess of the scavenger is calculated and added to the perfume microcapsule composition. In one embodiment, a fabric softening active may then be added to the resulting fabric care composition, i.e., the perfume microcapsule composition that contains the formaldehyde scavenger.

Any art-accepted method may be used to determine the amount or moles of free formaldehyde (in the perfume microcapsule composition or in the fabric care composition). Other methods may include the EPA method EPA 8315A, Determination of Carbonyl Compounds by High Performance Liquid Chromatography, and High-Performance Liquid Chromatographic Determination of Free Formaldehyde in Cosmetics Preserved with Dowicil 200, Journal of Chromatography, 502 (1990), pages 193-200. One example includes the following: formaldehyde is analyzed by means of room temperature derivatization with 2,4 dinitrophenyl hydrazine (DNPH) prior to a chromatographic separation using Reversed Phase Chromatography with UV/Visible spectrophotometric detection (wavelength setting at 365 nm). Calibration is performed through “External Standard calibration” with reference formaldehyde solution made up from commercially available 36-37% formaldehyde solution. Activity of the formaldehyde standard material can be determined via redox titration.

In yet still another embodiment, the formaldehyde scavenger reduces free formaldehyde, in the fabric care composition, in some embodiments to less than 50 parts per million (ppm), alternatively less than about 25 ppm, alternatively less than about 10 ppm, alternatively less than even 5 ppm, when the formaldehyde scavenger is used in excess molar concentrations of a β-ketoesters or a β-ketoamide of from about 15:1 to about 2.5:1, alternatively about 10:1 to about 2.5:1, alternatively about 5:1 to about 2.5:1 relative to the amount of free formaldehyde in the perfume microcapsule composition. In one embodiment, the ketoester or ketoamide is chosen from a β-ketoester or a β-ketoamide, respectively. Non-limiting examples include acetoacetamide or ethyl acetoacetate (Aldrich). Another example includes 16-diketene sizing agents (the diketene can ring open with any alcohol to yield a ketoester) such as those from Hercules.

In one embodiment, the formaldehyde scavenger reduces free formaldehyde, in the fabric care composition, in some embodiments to less than 50 parts per million (ppm), alternatively less than 20 ppm, alternatively less than 10 ppm, when the formaldehyde scavenger is used in excess molar concentrations of ethyl acetoacetate of from about 10:1 to about 3:1, alternatively from about 5:1 to about 3:1, relative to the amount of free formaldehyde in the perfume microcapsule composition.

In yet another embodiment, the formaldehyde scavenger is chosen from sodium bisulfite, ethyl acetoacetate, acetoacetamide, ethylenediamine-N,N′-bisacetoacetamide, ascorbic acid, 2,2-dimethyl-1,3-dioxan-4,6-dione, helional, triplal, lilial or combinations thereof can be used to achieve a low level of free formaldehyde levels in the compositions of the invention.

In another embodiment, the amount of scavenger in the fabric care composition comprises from about 0.01% to about 0.8%, alternatively from about 0.03% to about 0.4%, alternatively from about 0.065% to about 0.25%, by weight of the fabric care composition.

Perfume Microcapsule

One aspect of the invention provides for a fabric care composition comprising a perfume microcapsule. The term “perfume microcapsule” is used herein in the broadest sense to include a perfume core that is encapsulated by a shell. In turn, the perfume core comprises a perfume and optionally a diluent. The term “perfume” is used herein to mean any odoriferous material or any material which acts as a malodor counteractant. Non-limiting examples of a perfume are described in US 2003-0104969 A1, paragraphs 46-81. The term “diluent” means an inert material used to dilute the perfume that is encapsulated. Examples of diluents include isopropylmyristate, propylene glycol, poly(ethylene glycol), or mixtures thereof.

Perfume microcapsules may include those described in the following references: US 2003-215417 A1; US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. RE 32713; U.S. Pat. No. 4,234,627. For purposes of the present invention, and unless indicated otherwise, the term “perfume nanocapsule” is within the scope of the term “perfume microcapsule.” The shell material surrounding the perfume core to form the microcapsule can be any suitable polymeric material which is impervious or substantially impervious to the materials in the core (generally a liquid core) and the materials which may come in contact with the outer surface of the shell. In one embodiment, the material making the shell of the microcapsule comprises formaldehyde. Non-limiting examples of materials suitable for making the shell of the microcapsule include melamine-formaldehyde, urea-formaldehyde, phenol-formaldehyde, or other condensation polymers with formaldehyde. Other encapsulation techniques are disclosed in MICROENCAPSULATION: Methods and Industrial Applications, Edited by Benita and Simon (Marcel Dekker, Inc., 1996). Formaldehyde based resins such as melamine-formaldehyde or urea-formaldehyde resins are especially attractive for perfume encapsulation due to their wide availability and reasonable cost.

One preferred method for forming shell capsules useful herein is polycondensation, which may be used to produce aminoplast encapsulates. Aminoplast resins are the reaction products of one or more amines with one or more aldehydes, typically formaldehyde. Non-limiting examples of amines are melamine and its derivatives, urea, thiourea, benzoguanamine, and acetoguanamine and combinations of amines. Suitable cross-linking agents (eg. toluene diisocyante, divinyl benzene, butane diol diacrylate, etc) may also be used and secondary wall polymers may also be used as appropriate, as described in the art, e.g., anhydrides and their derivatives, particularly polymers and copolymers of maleic anhydride as disclosed in US 2004-0087477 A1.

Microcapsules having the liquid cores and polymer shell walls as described above can be prepared by any conventional process which produces capsules of the requisite size, friability and water-insolubility. Generally, such methods as coacervation and interfacial polymerization can be employed in known manner to produce microcapsules of the desired characteristics. Such methods are described in Ida et al, U.S. Pat. Nos. 3,870,542; 3,415,758; and 3,041,288.

In one embodiment, the microcapsules may vary in size (i.e., maximum diameter between is about 1 microns and about 75 microns, preferably between about 5 microns and about 30 microns). Furthermore, the capsules utilized in the present invention generally have an average shell thickness ranging from about 0.05 micron to 10 microns, preferably from about 0.05 micron to about 1 microns. Typically, but without limitation, capsules having a perfume loading of from about 50% to about 95% by weight of the capsule may be employed.

The perfume composition that is encapsulated may be comprised of 100% perfume components, or alternatively may include non-volatile materials such as diluents. The diluent may be present from about 0% to about 50% of the perfume formulation. The diluent can be selected from isopropyl myristate, polyethylene glycol, propane diol, or combinations thereof.

Generally speaking, the fabric care compositions of the invention may use from about 0.1% to about 2% by weight of the fabric care composition of encapsulated perfume, alternatively from about 0.15% to about 0.75%. In addition to the encapsulated perfume, neat perfume oil may also be added to the fabric care composition from about 0% to about 1.5% by weight of the fabric care composition containing the fabric softening active.

In one embodiment, the fabric care composition of the present invention comprises less than 500 parts per million (“ppm”) free formaldehyde, preferably less than 200 ppm, more preferably less than 50 ppm, more preferably less than 10 ppm and most preferably non-detectable, by analytical methods specific for formaldehyde.

Fabric Softening Active

Another aspect of the invention provides for a composition that is a fabric care composition comprising a fabric softening active (“FSA”). An FSA is used herein the broadest sense to include any active that is suitable for softening a fabric.

In one embodiment of the invention, the FSA is a quaternary ammonium compound suitable for softening fabric in a rinse step. In one embodiment, the FSA is formed from a reaction product of a fatty acid and an aminoalcohol obtaining mixtures of mono-, di-, and, in one embodiment, triester compounds. In another embodiment, the FSA comprises one or more softener quaternary ammonium compounds such, but not limited to, as a monoalkyquaternary ammonium compound, dialkylquaternary ammonium compound, a diamido quaternary compound, monester quaternary ammonium compound, diester quaternary ammonium compound, or a combination thereof.

In one aspect of the invention, the FSA comprises a diester quaternary ammonium (hereinafter “DQA”) compound composition. In certain embodiments of the present invention, the DQA compound compositions also encompass a description of diamido FSAs and FSAs with mixed amido and ester linkages as well as the aforementioned diester linkages, all herein referred to as DQA.

A first type of DQA (“DQA (1)”) that could be suitable as a FSA in the present invention includes a compound comprising the formula:
{R4-m-N+-[(CH2)n-Y—R1]m} X—
wherein each R substituent is either hydrogen, a short chain C₁-C₆, preferably C₁-C₃ alkyl or hydroxyalkyl group, e.g., methyl (most preferred), ethyl, propyl, hydroxyethyl, hydroxypropyl, and the like, poly(C₂₋₃ alkoxy), preferably polyethoxy, group, benzyl, or mixtures thereof; each m is 2 or 3; each n is from 1 to about 4, preferably 2; each Y is —O— (O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., tallow, hardended tallow, oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, palm oil, etc. Non-limiting examples of suitable fatty acids are listed in U.S. Pat. No. 5,759,990 at column 4, lines 45-66. In one embodiment the FSA comprises other actives in addition to DQA (1) or DQA. In yet another embodiment, the FSA comprises only DQA (1) or DQA and is free or essentially free of any other quaternary ammonium compounds or other actives. In yet another embodiment, the FSA comprises the precursor amine that is used to produce the DQA.

In another aspect of the invention, the FSA comprises a compound, identified as DTDMAC comprising the formula:
[R4-m-N(+)-R1m] A-
wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and branch or unbranched. In one embodiment, each R is H or a short chain C₁-C₆, preferably C₁-C₃ alkyl or hydroxyalkyl group, e.g., methyl (most preferred), ethyl, propyl, hydroxyethyl, and the like, benzyl, or (R²O)₂₋₄H where each R² is a C₁₋₆ alkylene group; and A⁻ is a softener compatible anion, preferably, chloride, bromide, methylsulfate, ethylsulfate, sulfate, phosphate, or nitrate; more preferably chloride or methyl sulfate. Examples of these FSAs include dialkydimethylammonium salts and dialkylenedimethylammonium salts such as ditallowdimethylammonium chloride and ditallowdimethylammonium methylsulfate. Examples of commercially available dialkyl(ene)dimethylammonium salts usable in the present invention are di-hydrogenated tallow dimethyl ammonium chloride and ditallowdimethyl ammonium chloride available from Degussa under the trade names Adogen® 442 and Adogen® 470 respectively. In one embodiment the FSA comprises other actives in addition to DTDMAC. In yet another embodiment, the FSA comprises only compounds of the DTDMAC and is free or essentially free of any other quaternary ammonium compounds or other actives.

In one embodiment, the FSA comprises an FSA described in U.S. Pat. Pub. No. 2004/0204337 A1, published Oct. 14, 2004 to Corona et al., from paragraphs 30-79.

In another embodiment, the FSA is one described in U.S. Pat. Pub. No. 2004/0229769 A1, published Nov. 18, 2005, to Smith et al., on paragraphs 26-31; or U.S. Pat. No. 6,494,920, at column 1, line 51 et seq. detailing an “esterquat” or a quaternized fatty acid triethanolamine ester salt.

In one embodiment, the FSA is chosen from at least one of the following:
ditallowoyloxyethyl dimethyl ammonium chloride, dihydrogenated-tallowoyloxyethyl dimethyl ammonium chloride, ditallow dimethyl ammonium chloride, dihydrogenatedtallow dimethyl ammonium chloride, ditallowoyloxyethyl methylhydroxyethylammonium methyl sulfate, dihydrogenated-tallowoyloxyethyl methyl hydroxyethylammonium chloride, or combinations thereof.

Typical minimum levels of incorporation of the FSA in the present fabric care compositions are at least about 1%, alternatively at least about 2%, alternatively at least about at least about 3%, alternatively at least about at least about 5%, alternatively at least about 10%, and alternatively at least about 12%, by weight of the fabric care composition. The fabric care composition may typically comprise maximum levels of FSA of about less than about 90%, alternatively less than about 40%, alternatively less than about 30%, alternatively less than about 20%, by weight of the composition.

In one embodiment of the invention, the FSA comprises a cationic starch. The FSA may comprise cationic starch and a quaternary ammonium compound. Cationic starch for use in fabric care compositions is described in US 2004-0204337 A1, paragraphs 16-29.

The fabric care compositions of the present invention may further comprise cationic starch (in addition to any other FSA) at a level of from about 0.01% to about 4%, alternatively 0.1% to about 3%, alternatively from about 0.2% to about 2.0%, alternatively from about 0.3% to about 2.5%, by weight of the fabric care composition.

Suitable cationic starches for use in the present compositions are commercially-available from Cerestar under the trade name C*BOND® and from National Starch and Chemical Company under the trade name CATO®.

Adjunct Ingredients

In another embodiment, the fabric care composition of the present invention may comprise any one or more adjunct ingredients. In yet another embodiment, the fabric care composition of the present invention may be free or essentially free of any one or more adjunct ingredients. The term “adjunct ingredients” may include: a perfume, dispersing agent, stabilizer, pH control agent, metal ion control agent, colorant, brightener, dye, odor control agent, pro-perfume, cyclodextrin, solvent, soil release polymer, preservative, antimicrobial agent, chlorine scavenger, enzyme, anti-shrinkage agent, fabric crisping agent, spotting agent, anti-oxidant, anti-corrosion agent, bodying agent, drape and form control agent, smoothness agent, static control agent, wrinkle control agent, sanitization agent, disinfecting agent, germ control agent, mold control agent, mildew control agent, antiviral agent, anti-microbial, drying agent, stain resistance agent, soil release agent, malodor control agent, fabric refreshing agent, chlorine bleach odor control agent, dye fixative, dye transfer inhibitor, color maintenance agent, color restoration/rejuvenation agent, anti-fading agent, whiteness enhancer, anti-abrasion agent, wear resistance agent, fabric integrity agent, anti-wear agent, and rinse aid, UV protection agent, sun fade inhibitor, insect repellent, anti-allergenic agent, enzyme, flame retardant, water proofing agent, fabric comfort agent, water conditioning agent, shrinkage resistance agent, stretch resistance agent, and combinations thereof. In one embodiment, the composition comprises an adjunct ingredient from about 0.001% to about 2% by weight of the composition.

In one embodiment, the pH of the fabric care composition may comprise a pH of from about 2 to about 6, alternatively from about 2 to about 4.5, alternatively from about 2.5 to about 4, and alternatively from about 3 to about 4.

In one embodiment, the fabric care composition is a fabric softening composition, alternatively a liquid fabric softening composition, alternatively a rinse-added fabric softening composition. In another embodiment, a method of manually treating fabric comprising the step of dosing a composition of the present invention in a first, preferably single, manual rinse laundry basin.

In another embodiment, an article is provided wherein the article comprises a unit dose of a fabric care composition of the present invention wherein a water soluble film (e.g., polyvinyl alcohol film) encapsulates the fabric care composition. The article may be used to treat fabric by being administered during the wash cycle, alternatively the rinse cycle, of an automatic laundry washing machine. Non-limiting examples of unit dose articles are described in US 2005/0202990 A1.

In one embodiment, the article is a water soluble unit dose, suitable for dosing in an automatic laundry washing machine, comprising a fabric care composition comprising a perfume microcapsule and a formaldehyde scavenger. The fabric care composition may further comprise a detersive surfactant and/or a fabric softener active; or alternatively the composition may comprise less than 5%, by weight of the composition, of a detersive surfactant and/or a fabric softener. In one embodiment, the composition comprises less than about 3%, alternatively less than about 1%, alternatively about 0%, by weight of the composition, each of a detergent surfactant and/or a fabric softening active.

Other Compositions

Other aspects of the invention include the use of formaldehyde scavengers of the present invention in laundry detergent compositions (e.g., TIDE), hard surface cleaners (e.g., MR CLEAN), automatic dishwashing liquids (e.g., CASCADE), dishwashing liquids (e.g., DAWN), and floor cleaners (e.g., SWIFFER). Non-limiting examples of cleaning compositions may include those described in U.S. Pat. Nos. 4,515,705; 4,537,706; 4,537,707; 4,550,862; 4,561,998; 4,597,898; 4,968,451; 5,565,145; 5,929,022; 6,294,514; and 6,376,445.

Methods

One aspect of the invention provides for a method of treating fabric comprising the step of dosing a fabric care composition/article/kit of the present invention to an automatic laundry machine or to a laundry handwashing basin.

Kits

One aspect of the invention provides a kit comprising a fabric care composition of the present invention. In one embodiment, the kit comprises instructions comprising instructions for use.

Method of Making Fabric Care Compositions

One aspect of the invention provides for a method of making a fabric care composition of the present invention comprising the steps:
(a) adding a formaldehyde scavenger to the perfume microcapsule composition to produce a formaldehyde scavenged perfume microcapsule composition;
(b) optionally adding, simultaneously or subsequently to step (a), the formaldehyde scavenged perfume microcapsule composition to a fabric softening active to produce a fabric care composition; and
(c) optionally heating the formaldehyde scavenged perfume microcapsule composition or fabric care composition from step (a) or step (b), respectively.

In one embodiment, the heating step of step (c) comprises heating the composition to a temperature from about 32° C. to a temperature of about 70° C. In another embodiment, the perfume microcapsule composition is free or substantially free of a fabric softening active.

Another aspect of the invention provides for a method of making a fabric care composition of the present invention comprising the steps:
(a) adding a formaldehyde scavenger to a perfume microcapsule composition, wherein the perfume microcapsule composition comprises free formaldehyde, to produce a formaldehyde scavenged perfume microcapsule composition, wherein the formaldehyde scavenged perfume microcapsule composition comprises a reaction product of the formaldehyde scavenger reacting with the free formaldehyde;
(b) purifying the formaldehyde scavenged perfume microcapsule composition of step (a) to reduce the amount of said reaction product to produce a purified formaldehyde scavenged perfume microcapsule composition;
(c) optionally adding, preferably subsequently to step (b), a fabric softening active to the purified formaldehyde scavenged perfume microcapsule composition to produce a fabric care composition;
(d) optionally heating the formaldehyde scavenged perfume microcapsule composition or fabric care composition from step (a) or step (c), respectively.
(e) optionally, adding a formaldehyde scavenger to a microcapsule slurry that is produced by redispersing dried microcapsules in water. Preferably, the aqueous microcapsule slurry is spray dried using a co-current dryer (inlet air temperature 180° C., outlet air temperature 95° C., centrifugal atomization) to produce a free flowing, dry powder.

In one embodiment, the heating step of step (d) comprises heating the composition to a temperature from about 32° C. to a temperature of about 70° C. In another embodiment, the perfume microcapsule composition is free or substantially free of a fabric softening active. In one embodiment, the step of “purifying” comprises washing the formaldehyde scavenged perfume microcapsule composition from about 1 to about 10 times by isolating the perfume microcapsules from the aqueous solution by centrifuging or filtering, adding water until the original volume is achieved, mixing the perfume microcapsule composition, and isolating the perfume microcapsules. The aqueous solutions from the iterative washing steps are discarded. Purifying may also comprise steps, preferably subsequent to washing, that include filtering, siphoning, or centrifuging said reaction product. In one embodiment, the formaldehyde scavenger may be dissolved in an aqueous composition. In another embodiment, the formaldehyde scavenger may be attached to an insoluble material such as a membrane filter, a polymer film, or an insoluble resin.

In another embodiment, free formaldehyde can further be reduced by spraying with inert gas, spray-drying, or distilling the free formaldehyde under pressure to remove residual formaldehyde from a composition, preferably from a perfume microcapsule composition. Oxidation of the formaldehyde to formic acid may also be done using an oxidant, including but not limited to, hydrogen peroxide.

### EXAMPLES

The following are non-limiting examples of the fabric care compositions of the present invention.

| | EXAMPLES | | | | | | | | |
|---|---|---|---|---|---|---|---|---|---|
| (% wt) | I | II | III | IV | V | VI | VII | VIII | IX |
| FSA^{a} | 14 | 16.47 | 14 | 12 | 12 | 16.47 | — | — | 5 |
| FSA^{b} | | | | | — | 3.00 | — | — | |
| FSA^{c} | | | | | — | — | 6.5 | — | |
| Ethanol | 2.18 | 2.57 | 2.18 | 1.95 | 1.95 | 2.57 | — | — | 0.81 |
| Isopropyl | — | — | — | — | — | — | 0.33 | 1.22 | — |
| Alcohol | | | | | | | | | |
| Starch^{d} | 1.25 | 1.47 | 2.00 | 1.25 | — | 2.30 | 0.5 | 0.70 | 0.71 |
| Perfume | 0.9 | 0.90 | 0.4 | 1.5 | 1.0 | 1.20 | 1.30 | 0.8-1.5 | 0.6 |
| Encapsulated | 0.6 | 0.75 | 0.6 | 0.75 | 0.37 | 0.60 | 0.37 | 0.6 | 0.37 |
| Perfume | | | | | | | | | |
| Formaldehyde | 0.40 | 0.13 | 0.065 | 0.25 | 0.03 | 0.030 | 0.030 | 0.065 | 0.03 |
| Scavenger^{e} | | | | | | | | | |
| Phase | 0.21 | 0.25 | 0.21 | 0.21 | 0.14 | — | — | 0.14 | — |
| Stabilizing | | | | | | | | | |
| Polymer^{f} | | | | | | | | | |
| Suds | — | — | — | — | — | — | — | 0.1 | — |
| Suppressor^{g} | | | | | | | | | |
| Calcium | 0.15 | 0.176 | 0.15 | 0.15 | 0.30 | 0.176 | — | 0.1-0.15 | — |
| Chloride | | | | | | | | | |
| DTPA^{h} | 0.017 | 0.017 | 0.017 | 0.017 | 0.007 | 0.007 | 0.20 | — | 0.002 |
| Preservative | 5 | 5 | 5 | 5 | 5 | 5 | — | 250^{j} | 5 |
| (ppm)^{i,j} | | | | | | | | | |
| Antifoam^{k} | 0.015 | 0.018 | 0.015 | 0.015 | 0.015 | 0.015 | — | — | 0.015 |
| Dye | 40 | 40 | 40 | 40 | 40 | 40 | 11 | 30-300 | 30 |
| (ppm) | | | | | | | | | |
| Ammonium | 0.100 | 0.118 | 0.100 | 0.100 | 0.115 | 0.115 | — | — | — |
| Chloride | | | | | | | | | |
| HCl | 0.012 | 0.014 | 0.012 | 0.012 | 0.028 | 0.028 | 0.016 | 0.025 | 0.011 |
| Structurant^{l} | 0.01 | 0.01 | 0.01 | 0.01 | 0.01 | 0.01 | 0.01 | 0.01 | 0.01 |
| Deionized | Balance | Balance | Balance | Balance | Balance | Balance | Balance | Balance | Balance |
| Water | | | | | | | | | |
| | EXAMPLES | | | | | | | | |
| (% wt) | X | XI | XII | XIII | XIV | XV | XVI | XVII | XVIII |
| FSA^{a} | 14 | 16.47 | 14 | 12 | 12 | 16.47 | — | — | 5 |
| FSA^{b} | | | | | — | 3.00 | — | — | |
| FSA^{c} | | | | | — | — | 6.5 | — | |
| Ethanol | 2.18 | 2.57 | 2.18 | 1.95 | 1.95 | 2.57 | — | — | 0.81 |
| Isopropyl | — | — | — | — | — | — | 0.33 | 1.22 | — |
| Alcohol | | | | | | | | | |
| Starch^{d} | 1.25 | 1.47 | 2.00 | 1.25 | — | 2.30 | 0.5 | 0.70 | 0.71 |
| Encapsulated | 0.6 | 0.75 | 0.6 | 0.75 | 0.37 | 0.60 | 0.37 | 0.6 | 0.37 |
| Perfume | | | | | | | | | |
| Formaldehyde | 0.40 | 0.13 | 0.065 | 0.25 | 0.03 | 0.030 | 0.030 | 0.065 | 0.03 |
| Scavenger^{e} | | | | | | | | | |
| Phase | 0.21 | 0.25 | 0.21 | 0.21 | 0.14 | — | — | 0.14 | — |
| Stabilizing | | | | | | | | | |
| Polymer^{f} | | | | | | | | | |
| Suds | — | — | — | — | — | — | — | 0.1 | — |
| Suppressor^{g} | | | | | | | | | |
| Calcium | 0.15 | 0.176 | 0.15 | 0.15 | 0.30 | 0.176 | — | 0.1-0.15 | — |
| Chloride | | | | | | | | | |
| DTPA^{h} | 0.017 | 0.017 | 0.017 | 0.017 | 0.007 | 0.007 | 0.20 | — | 0.002 |
| Preservative | 5 | 5 | 5 | 5 | 5 | 5 | — | 250^{j} | 5 |
| (ppm)^{i,j} | | | | | | | | | |
| Antifoam^{k} | 0.015 | 0.018 | 0.015 | 0.015 | 0.015 | 0.015 | — | — | 0.015 |
| Dye | 40 | 40 | 40 | 40 | 40 | 40 | 11 | 30-300 | 30 |
| (ppm) | | | | | | | | | |
| Ammonium | 0.100 | 0.118 | 0.100 | 0.100 | 0.115 | 0.115 | — | — | — |
| Chloride | | | | | | | | | |
| HCl | 0.012 | 0.014 | 0.012 | 0.012 | 0.028 | 0.028 | 0.016 | 0.025 | 0.011 |
| Structurant^{l} | 0.01 | 0.01 | 0.01 | 0.01 | 0.01 | 0.01 | 0.01 | 0.01 | 0.01 |
| Deionized | Balance | Balance | Balance | Balance | Balance | Balance | Balance | Balance | Balance |
| Water | | | | | | | | | |

^{a}N,N-di(tallowoyloxyethyl)-N,N-dimethylammonium chloride.
^{b}Methyl bis(tallow amidoethyl)2-hydroxyethyl ammonium methyl sulfate.
^{c}Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{d}Cationic high amylose maize starch available from National Starch under the trade name CATO ®.
^{e}The formaldehyde scavenger is acetoacetamide available from Aldrich.
^{f}Copolymer of ethylene oxide and terephthalate having the formula described in U.S. Pat. No. 5,574,179 at col.15, lines 1-5, wherein each X is methyl, each n is 40, u is 4, each R1 is essentially 1,4-phenylene moieties, each R2 is essentially ethylene, 1,2-propylene moieties, or mixtures thereof.
^{g}SE39 from Wacker
^{h}Diethylenetriaminepentaacetic acid.
ⁱKATHON ®CG available from Rohm and Haas Co. “PPM”is “parts per million.”
^{j}Gluteraldehyde
^{k}Silicone antifoam agent available from Dow Corning Corp. under the trade name DC2310.
^{l}Hydrophobically-modified ethoxylated urethane available from Rohm and Haas under the tradename Aculan 44.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein. All parts, ratios, and percentages herein, in the Specification, Examples, and claims, are by weight and all numerical limits are used with the normal degree of accuracy afforded by the art, unless otherwise specified.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric care composition comprising a fabric softening active and a formaldehyde scavenger, provided the formaldehyde scavenger does not comprise ammonia, ethylene urea, tryptophan, 5-hydroxytryptophan, hydroxyl amine, hydroxyl amine sulfate, or barbituric acid.

2. The fabric care composition of claim 1, wherein the composition further comprises a perfume microcapsule.

3. The fabric care composition of claim 2, wherein the perfume microcapsule comprises a shell and wherein the shell comprises a condensation polymer with formaldehyde.

4. The fabric care composition of claim 3, wherein the condensation polymer with formaldehyde is chosen from melamine-formaldehyde, urea-formaldehyde, phenol-formaldehyde, or mixtures thereof.

5. The fabric care composition of claim 2, wherein the pH comprises from about 2 to about 6.

6. The fabric care composition of claim 5, wherein the composition comprises from about 0.03% to about 0.4% by weight of the composition of the formaldehyde scavenger.

7. The fabric care composition of claim 6, wherein the composition comprises from about 0.15% to about 0.75% by weight of the composition is encapsulated perfume.

8. The fabric care composition of claim 6, wherein the composition comprises from about 5% to about 16% by weight of the composition the fabric softening active.

9. The fabric care composition of claim 8, wherein the fabric softening active is a quaternary ammonium compound.

10. The fabric care composition of claim 9, wherein the formaldehyde scavenger is chosen from sodium bisulfite, urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), poly(vinyl amine), hexane diol, ethylenediamine-N,N′-bisacetoacetamide, N-(2-ethylhexyl)acetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, benzylamine, hydroxycitronellol, cyclohexanone, 2-butanone, pentane dione, dehydroacetic acid, chitosan, or a mixture thereof.

11. The fabric care composition of claim 9, wherein the formaldehyde scavenger is chosen from sodium bisulfite, ethyl acetoacetate, acetoacetamide, ethylenediamine-N,N′-bisacetoacetamide, ascorbic acid, 2,2-dimethyl-1,3-dioxan-4,6-dione, helional, triplal, lilial or a mixture thereof.

12. The fabric care composition of claim 1, wherein the formaldehyde scavenger comprises a β-ketoester or a β-ketoamide.

13. The fabric care composition of claim 12, wherein the formaldehyde scavenger is chosen from acetoacetamide or ethyl acetoacetate or combinations thereof.

14. The fabric care composition of claim 1, wherein the formaldehyde scavenger is chosen from sodium bisulfite, urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), poly(vinyl amine), hexane diol, ethylenediamine-N,N′-bisacetoacetamide, N-(2-ethylhexyl)acetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-Dimethyl-1,3-dioxan-4,6-dione, 2-pentanone, dibutyl amine, triethylenetetramine, benzylamine, hydroxycitronellol, cyclohexanone, 2-butanone, pentane dione, dehydroacetic acid, chitosan, or a mixture thereof.

15. The fabric care composition of claim 1, wherein the formaldehyde scavenger is chosen from sodium bisulfite, ethyl acetoacetate, acetoacetamide, ethylenediamine-N,N′-bisacetoacetamide, ascorbic acid, 2,2-dimethyl-1,3-dioxan-4,6-dione, helional, triplal, lilial or a mixture thereof.

16. The fabric care composition of claim 1, wherein the composition comprises less than about 100 ppm free formaldehyde.

17. A method of softening a fabric comprising the step of dosing a composition according to claim 1 in a rinse cycle of an automatic laundry machine.

18. An article comprising a composition according to claim 1.

19. A method of treating a fabric comprising the step of dosing a composition according to claim 1 in an automatic laundry machine.
